(19) United States
(12) Patent Application Publication
(10) Pub. No.: US 2003/0084822 A1
(43) Pub. Date: May 8, 2003

(54) Cementitious composition

(76) Inventor: Peter Hamish Barrow, Ardmore (NZ)

Correspondence Address: Stephen S. Ashley, Jr., Adams, Schwartz & Evans, P.A., 2180 Two Wachovia Center, Charlotte, NC, 28282, US

(21) Appl. No.: 10/282,886

(22) Filed: Oct. 29, 2002

Related U.S. Application Data
(63) Continuation of application No. 09/423,033, filed on Oct. 29, 1999, now abandoned.
Application No. 09/423,033 is a 371 of international application No. PCT/NZ98/00052, filed on Apr. 30, 1998.

(30) Foreign Application Priority Data
May 1, 1997 (NZ) 314721

(51) Int. Cl. C04B 16/04

(52) U.S. Cl. 106/724

(57) ABSTRACT

A cementitious composition is provided which contains between 25% to 90% plastics particles (102) and has no conventional rock aggregate present. A heterogeneous population of plastics particles (102) may be present and the particles are preferably obtained from wastestream plastics materials. Articles (101) made form the cementitious composition are lightweight and may be utilised in building-related industries.

### TECHNICAL FIELD OF THE INVENTION

The present invention relates to cementitious compositions and is particularly, but not exclusively, applicable to cementitious compositions for use in the building industry or related industries.

### BACKGROUND

Cementitious building and paving products are well known and may include such items as bricks, concrete, paving stones, roofing tiles, blocks, decorative items, and the like. An undesirable feature which may be associated with such cementitious products is their high density.

Some clay and cementitious building materials are known that contain polystyrene beads or the like. This may at least go some way towards providing a lightweight material for use in the building industry or related industries.

Presently, only a small percentage of the plastics materials that are set aside for recycling are in fact recycled due to the time and cost of sorting the plastics into their differing types and washing the plastic before each type of plastic can be processed further. As a result a large percentage of such materials may be placed in landfills.

Plastics are the fastest growing municipal solid waste component in the USA and other wealthy countries, and there is increasing public demand for recycling (Hadjilambrinos 1996). However, plastics are exceedingly difficult to recycle efficiently with currently available technology in industrialised societies. Current plastics recycling technology is essentially limited to remelting and reprocessing thermoplastics and regranding cured thermosets for blending with virgin resin (Tesoro and Wu 1995); conventional methodology works well when large volumes of clean, single-polymer articles (for instance PET soda bottles, HDPE milk containers) are available in steady volumes. These materials however comprise only a fraction of the total plastic in most municipal wastestreams. Much of the plastic material in municipal wastes is multi-layered, heavily pigmented, contaminated and difficult to sort (Mackey 1995). Even highly trained human sorters can readily recognise only a few types of plastics (Hadjilambrinos 1996). The need to separate the various plastic types makes recycling of plastics technically difficult and expensive. The problem is exacerbated by the low cost of virgin resins. “Traditional” recycling is capable of dealing with just a small portion of the total volume of waste plastic generated by society.

Currently there are only limited markets for recycled high density polyethylene (HDPE) and polyethylene terephthalate (PET); supply outpaces demand for these commodities in New Zealand.

Automotive plastics such as acrylonitrile-butadiene-styrene (ABS), polyvinyl chloride (PVC) and polyurethane present particular problems for recycling (Day et al 1996); furthermore, vehicle components made from plastics are commonly composed of several compositionally-distinct components and often contain fillers such as talc or wood flour, the presence of which hinders recycling.

Methods of recycling plastics materials by incorporating relatively small volumes into conventional rock aggregate concrete are known. Such methods may still require a certain amount of processing (sorting and washing) of the plastics materials before these can be used.

### OBJECT

It is an object of the present invention to provide a cementitious composition which utilises a proportion of plastics materials, preferably from the wastestream, or to at least provide the public with a useful choice.

These and other objects of the present invention will become apparent from consideration of this specification as a whole.

### STATEMENT OF INVENTION

In one aspect of the present invention there is provided a cementitious composition comprising at least cement and a mixture of particles of substantially plastics materials in the range of 25% to 90% (by volume) of the composition.

Preferably said cementitious composition contains 30% to 60% mixture of particles of substantially plastics materials.

Preferably said mixture of particles of substantially plastics materials is derived from at least one of high density polyethylene, polypropylene, PVC, ABS, polyurethane, polyamide, and PET.

Preferably the cementitious composition further contains at least one of a fine aggregate and other additives.

More preferably the cementitious composition further contains an appropriate quantity of water.

In a related aspect of the present invention there is provided a cementitious article constructed from a composition according to the preceding paragraph.

In a further related aspect of the present invention there is provided a method of making a cementitious article comprising the steps of: collecting a quantity of particles of substantially plastics materials, providing at the least cement and a quantity of water, combining particles of substantially plastics materials with cement and water such that a composition containing 25% to 90% particles of substantially plastics materials results, working the composition and allowing the mix to set and cure.

Preferably said method of making a cementitious article further comprises the step of combining at least one of a fine aggregate and appropriate additives with the particles of substantially plastics materials, cement and water.

In a related aspect of the present invention there is provided a cementitious article constructed according to the method of either of the two preceding paragraphs.

### DRAWINGS

One preferred embodiment of the present invention is described, by way of example only, with reference to the accompanying figures in which:

FIG. 1 is a horizontal cross sectional view of a cementitious article produced according to the present invention;

FIG. 2 is a vertical cross sectional view of a cementitious article produced according to the present invention.

### PREFERRED EMBODIMENT

The following description details the preferred embodiments of the present invention. They are given by way of example only and it will be appreciated by those skilled in the field that a number of variations may be made to the examples without departing from the scope of the present invention.

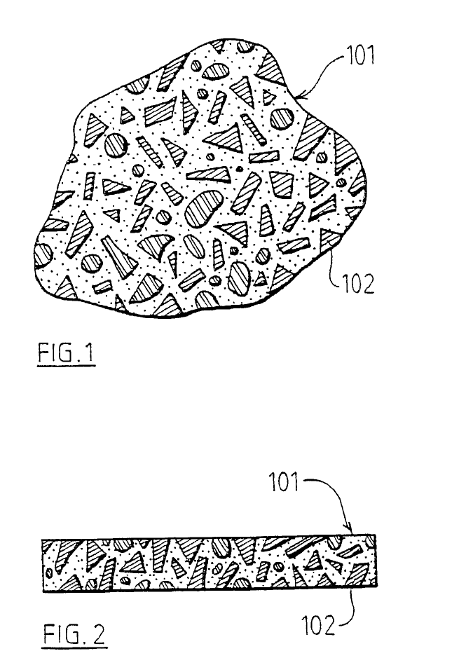

In one preferred form of the present invention there is provided a cementitious article or building material 101 containing a quantity of recycled plastics particles 102. Such particles may be in the form of granulated, flaked, chipped or by other means comminuted plastics materials. Such plastics particles 102 are formed from a gallimaufry, or a variety of different types, of plastics items as described below thus producing a heterogeneous population of plastics granule however, it would also be possible to use a single type of plastics material. In this particular embodiment of the invention the particles 102 are in granulated form and are derived from two different types of plastics materials, namely polypropylene and polyethylene (indicated by different shading on FIGS. 1 and 2). As can be seen from FIGS. 1 and 2 the plastics granules 102 are dispersed relatively evenly throughout the cementitious article 101.

As an alternative to the above, the plastics particles may be in the form of thin (3 mm width or diameter) extrusions of random length.

The plastics particles or granules 102 of the preferred embodiment are made by collecting precursor plastics materials intended for recycling (such as drink bottles, household cleaner bottles and the like) and, without sorting the precursors by type of plastic, granulating the plastics in an appropriate machine. Alternatively, those plastics materials which are unable to be recycled and may be destined for landfill may be utilised. In addition, one may use virgin plastics materials albeit at a higher cost.

The precursor plastics items described above may be constructed from a variety of different plastics materials such as HDPE, polypropylene, PVC, ABS, polyurethane, polyamide, PET and other rigid plastics materials and the like. In addition, post-consumer scrap plastics items are suitable for use in the present invention.

In this particular embodiment of the present invention the heterogeneous mix of plastics granules 102 produced may vary in size, shape and composition. However, it is preferable that the maximum particle dimension range is between approximately 3-15 mm.

It should be noted that where plastics destined for recycling are used it is not necessary for small amounts of other waste materials such as glass and wood to be sorted from the plastics materials; this may help reduce the potential cost of the present invention and the time spent processing the plastics materials

The cementitious article 101 of the invention may generally be described as being formed by a cementitious composition composed of plastics materials and at least cement at a certain ratio by volume. In the process of producing the article 101 an appropriate quantity of water will be added to the general composition.

Appropriate cements for use in the present invention include ordinary portland cement, high alumina cement, sorel cement, sulphate-resisting cements and low-heat portland cement and the like.

In addition to cement and plastics the composition of the present invention may also contain at least one of; fine aggregate (sand such as quartzose or feldspatholithic sand or the like), and other additives (eg stabilisers; plasticiser; air entrainment agents; additives conferring sulphate resistance; curing accelerators; setting retardants; colourants; diatomaceous earth (ground or otherwise); ground granulated blast-furnace slag and pulverised fuel ash. Other additives known to those skilled in the art should not be excluded.

The above mentioned additives will be present in the cementitious composition at relatively small amounts only. For example, calcium chloride may be utilised as an accelerant at 0.3-0.5% by weight of total cementitious composition. Generally, other additives are used in significantly lower amounts.

It should be noted that pozzolanic substances including, but not limited to, condensed silica fume, pulverised rhyolite, and dacite may also form a part of the cementitious composition of the present invention. Such substances are generally present in larger volumes when compared to the other additives abovementioned and are used to displace some of the cement content of the composition. The use of such substances will be well known by those skilled in the field.

As an alternative ground glass may be untilised as a fine aggregate component to replace some or all of the sand. In this case one would need to take the necessary precautions to remove or minimise any deleterious alkali-silica reactions that may occur; for example using a low-alkali portland cement and the use of a pozzolana. In this way, automotive and other types of waste glass which are difficult to recycle may be utilised.

One preferred example of the cementitious article 101 of the present invention is formed from a cementitious composition in which plastics, cement and a fine aggregate in the form of sand are present in the proportions given below:

40% (by volume) heterogeneous mix of granulated plastics' materials (polypropylene and polyethylene);

20% (by volume) cement;

40% (by volume) sand; plasticiser.

Note, the plasticiser is generally added in small amounts; the exact amount may be varied according to the application to which the mix will subsequently be put.

Further examples in which a conventional fine aggregate (sand) is present comprise:

a) 25% (by volume) plastics, 15% (by volume) cement, 60% (by volume) sand;

b) 33.3% (by volume) plastics, 33.3% (by volume) cement, 33.3% (by volume) sand;

c) 50% (by volume) plastics, 10% (by volume) cement, 40% (by volume) sand.

As mentioned above other additives, such as concrete stabilisers and other additives known in the trade, may also be incorporated into the above general compositions.

In a second preferred example of the invention the heterogeneous plastics mix replaces all of the fine aggregate material used in known cementitious mixes; ie the plastics mix will replace not only all of the gravel or crushed rock aggregate but also all of the sand component.

In this preferred example the cementitious article 101 may be formed from a cementitious composition containing approximately:

a) 75% (by volume) plastic to 25% (by volume) cement; or

b) 66.6% (by volume) plastic to 33.3% (by volume) cement; or

c) 80% (by volume) plastic to 20% (by volume) cement; or

d) 90% (by volume) plastic to 10% (by volume) cement.

Again the above examples may further contain amounts of suitable additives as described in relation to the first preferred example.

From the above examples it is noted that it is appropriate for the cementitious compositions of the present invention to be formed using plastics contents covering the range 25% to 90% by volume. The exact amount of plastics materials used may depend on the application to which the final material made is to be put. It should be noted that all percentages by volume given in this description relate to volume of the constituents in dry form.

The cementitions composition of the present invention is formed from the components described in the above examples by combining the components in the following manner: combining the sand and/or cement (and other optional additives) with an amount of water sufficient to result in a cementitious mixture of a desired consistency for a particular application, adding and combining the granulated plastics so as to form a substantially homogeneous mixture. The cementitious composition may then be worked (eg moulded, poured, cast or the like), and allowed to set and cure. However, it is possible to combine the components of the composition in a number of alternative ways; for example, the sand and/or cement and plastics could be combined and then water may be added.

TESTING

Quantitative tests, including unconfined compressive strength testing, calculation of thermal conductivity and density measurements have been conducted on materials formed using the cementitious compositions of the present invention. Qualitative tests performed include those to access the following properties:

| | Unqualified assessment |
|---|---|
| Property | of performance |
| shatter resistance | good |
| fire resistance | fair |
| flexural properties | fair |
| wear resistance | fair |
| resistance to fading | good |
| machinability (sawing, nailing, drilling and | excellent |
| grinding) | |
| mixability and castability | very good |

The physical characteristics of a range of materials/articles made using the binary composition (composition containing plastics and cement) and the ternary composition (composition containing plastics and cement and sand) relative to those of low density semi-structural concrete prepared with natural or artificial low-density silicate aggregate (eg pumice, lytag; expanded vermiculite) are summarised in the following table.

| | Binary | Ternary | Low-density |
|---|---|---|---|
| Property | composition | composition | concrete |
| density | low | low | low |
| permeability | very low | low | moderate to high |
| machinability | excellent | good | very poor |
| workability | fair | good | good |
| thermal conductivity | very good | good | very poor |
| strength | moderate | moderate | moderate |
| toughness | good | moderate | poor |

Unconfined compressive strength figures of up to 17.5 MPa have been achieved using a composition containing portland cement (33.33% by volume), granulated waste plastics (largely polypropylene and polyethylene), (33.33% by volume) and quartzofeldspathic sand (33.33% by volume). The tests were conducted on 14 day old materials formed from the cementitious composition described above. The saturated density of the test piece was 1.72 gcm⁻³ (compared to conventional concrete which typically has a saturated density of 2.4 gcm⁻¹).

ADVANTAGES

In relation to the materials produced from the cementitious composition of the second preferred example (no sand (fine aggregate) present) they have a further advantage in that the likelihood of deleterious alkali-aggregate reactions is exceedingly low. This is due to the fact that the aggregate component is completely free of silica.

As indicated above under ‘Testing’ various studies on the physical properties, among other things, of the cementitious articles produced using the cementitious compositions of the preferred embodiments of the present invention have been conducted. During the studies it has been shown that the materials have outstanding machinability and can be nailed ground, sawn and drilled either with machine tools or by hand. In addition, the materials have superior flexural properties and impact resistance.

The materials made using the compositions of the present invention have low permeability when compared to conventional rock aggregate concrete products.

The abrasive nature of the coarse aggregate present in conventional concrete mixes may result in substantial wear and tear on equipment used to pump the mix during laying concrete for example. As the cementitious composition of the present invention contains no coarse aggregate there may be less wear and tear on pumping equipment In addition, the absence of rock aggregate allows it to be extruded or pumped with greater ease than conventional concrete; it may be pumped further distances and at faster speeds.

The materials produced using the cementitious composition of the present invention are low cost and lightweight. The use of such materials has the advantage of reducing transport costs relative to conventional rock-aggregate concrete materials.

It should be noted that recycled plastics materials of the kinds used in the present invention are believed not to break down and leach toxins into the environment. Other known additives to concrete, such as polystyrene and foam, may break down to produce toxic by-products such as chloro-fluoro carbons (CFC's).

APPLICATIONS

The cementitious composition of the present invention may be used in a variety of applications in the building industry and related industries. For example, it is believed that the cementitious article 101 of the preferred embodiment of the invention has good thermal conductivity due to the amount of thermally conductive recycled plastic materials used. In addition, it has a very low density and is thus light-weight. Thus, the product may be applicable to the roofing industry for example. Roofing tiles formed from the composition of the present invention may allow the number of supporting beams in the frame of a building necessary to support the roof to be reduced. The composition of the present invention may also be useful as a low cost low density space filler; for example, for filling hollow concrete blocks used in the building industry.

Construction of various types of building materials with the cementitious composition of the present invention may also confer on the building materials a resilient property, in other words the product will have more give in its structure. Such a property may be advantageous in a variety of applications.

By treating the surface of an item made with the cementitious composition of the present invention with an appropriate surface retardant (eg RUGASOL™) the plastic granules will be exposed. Alternatively, sand blasting, shot-blasting and bush-hammering may be utilised to expose the plastics particles on the surface of the item. Exposing the plastic contained in the cementitious article of the invention may form a product with an additional aesthetic value. As the plastic used in this invention will generally contain UV stabilisers any potential problem involving the fading of the exposed plastics particles may be avoided. The range of colours available from wastestream plastics greatly exceeds that available by using natural rock aggregate to create similar effects. It may also be possible to sort the plastics materials by colour prior to combining with the cement mix so that materials produced are substantially one colour (due to the plastics present).

Other uses for materials constructed using the cementitious composition of the present invention may include: concrete, bricks, blocks, pipes, paving stones, tiles and garden ornaments.

In addition to the above applications the present invention also goes some way to recycle plastics materials that may otherwise not be recycled.

References

Day M, Cooney J D, Klein C, and Fox J (1996): Thermal degradation of automotive plastics—a possible recycling opportunity. Advances in Chemistry Series 249: 47-57.

Hadjilambrinos C (1996): A review of plastics recycling in the USA with policy recommendations. Environmental Conservation 23: 298-306.

Mackey G (1995): A review of advanced recycling technology. ACS Symposium Series 609: 161-169.

Tesoro G and Wu Y (1995): Polymer recycling research in the new decade. ACS Symposium Series 609: 502-510.

1. A cementitious composition comprising at least cement and a mixture of particles of substantially plastics materials in the range of 25% to 90% (by volume) of the composition.

2. A cementitious composition as claimed in claim 1 wherein the composition contains 30% to 60% mixture of particles of substantially plastics materials.

3. A cementitious composition as claimed in any one of claims 1 or 2 wherein the mixture of particles of substantially plastics materials is derived from at least one of high density polyethylene, polypropylene, PVC, ABS, polyurethane, polyamide, and PET.

4. A cementitious composition as claimed in any one of claims 1 to 3 wherein the composition further contains at least one of a fine aggregate and other additives.

5. A cementitious composition as claimed in claim 4 wherein the composition further contains an appropriate quantity of water.

6. A cementitious article constructed from a composition according to claim 5.

7. A method of making a cementitious article comprising the steps of: collecting a quantity of particles of substantially plastics materials, providing at the least cement and a quantity qf water, combining particles of substantially plastics materials with cement and water such that a composition containing 25% to 90% particles of substantially plastics materials results, working the composition and allowing the mix to set and cure.

8. A method of making a cementitious article as claimed in claim 7 wherein the method further comprises the step of combining at least one of a fine aggregate and appropriate additives with the particles of substantially plastics materials, cement and water.

9. A cementitious article constructed according to the method of claim 8.
